(19) United States
(12) Patent Application Publication
(10) Pub. No.: US 2004/0081209 A1
(43) Pub. Date: Apr. 29, 2004

(54) Communication service unit and multimedia communication method

(76) Inventors: Takeshi Mio, Tokyo (JP); Susumu Oka, Tokyo (JP); Yukinari Matsuda, Tokyo (JP); Morio Yoshimoto, Tokyo (JP)

Correspondence Address: BIRCH STEWART KOLASCH & BIRCH, PO BOX 747, FALLS CHURCH, VA, 22040-0747, US

(21) Appl. No.: 10/220,735

(22) PCT Filed: Dec. 27, 2001
(86) PCT No.: PCT/JP01/11594

(30) Foreign Application Priority Data
Jan. 11, 2001 (JP) 2001-003622

(51) Int. Cl. H04J 3/04

(52) U.S. Cl. 370/535; 370/465

(57) ABSTRACT

A communication service unit 2 exchanges messages related to establishment or reestablishment of a logical channel for video with a reception terminal 3, when transmission of a video coded signal to the reception terminal 3 is started or when a transmission source terminal is changed. The communication service unit 2 adds a video coding parameter stored in memory and used in a new transmission source terminal to a message for establishing or re-establishing the logical channel for video and transmits transmitting the resultant message to the reception terminal 3. The reception terminal 3 decodes the video coded signal based on the video coding parameter included in the message thus received.

### TECHNICAL FIELD

The present invention generally relates to communication service units and multimedia communication methods and, more particularly, to a communication service unit and a multimedia communication method in which information transmitted from a plurality of transmission terminals is demultiplexed into media information of a single or a plurality of media types, a transmission terminal for transmitting the media information to a reception terminal is selected for each media type, the media information is processed as required, and the media information of a plurality of media types thus processed is multiplexed, so as to transmit the media information thus multiplexed to a single or a plurality of reception terminals.

### BACKGROUND ART

A related-art communication terminal using a video encoding method such as MPEG4 is configured to transmit, to a reception multimedia communication terminal a video coding parameter required in the process of decoding a video coded signal, when a logical channel used for transferring the video coded signal is established, or when the transmission of the vide coded signal is started.

Since the communication service unit and the multimedia communication method according to the related art operate as described above, when the communication service unit, capable of demultiplexing multiplexed media information transmitted from a plurality of transmission terminals, selecting information of a desired media type, processing the selected media information as required and multiplexing the media information of a plurality of media types, and transmitting the multiplexed media information to a single or a plurality of reception terminals, switches from a first transmission terminal to a second transmission terminal for transmission to a reception terminal, the reception terminal may fail to recognize a new media coding parameter used in the second transmission terminal and different from the media coding parameter used in the first transmission terminal. When this failure occurs, performance of signal processing suffers.

The present invention is developed with an aim to removing the disadvantage described above and has an objective of providing a communication service unit and a multimedia communication method in which a media decoding process is efficiently performed in a reception terminal when the terminal switches its reception to media information of a different type.

### DISCLOSURE OF THE INVENTION

The communication service unit according to the invention is configured such that, when a transmission source terminal is changed for one or a plurality of media types, a media coding parameter stored in memory and used in a new transmission source terminal is supplied to a reception terminal.

Accordingly, it is possible for the reception terminal to perform media decoding when a media coded signal transmitted thereto is changed.

The communication service unit according to the invention is configured such that when communication is started, transmission terminals are controlled to use for media coding of a given media type or given media types, a common media coding parameter that the entirety of the reception terminals in a given group use for decoding.

Accordingly, it is possible for the reception terminal to perform media decoding when a media coded signal transmitted thereto is changed.

The communication service unit according to the invention is configured such that when communication is started, transmission terminals are controlled to use, for media coding of a given media type or given media types, a media coding method that uniquely determines a media coding parameter for the entirety of the transmission terminals and the reception terminals in a given group.

Accordingly, it is possible for the reception terminal to perform media decoding when a media coded signal transmitted thereto is changed.

The communication method according to the invention is configured such that, when a transmission source terminal is changed for one or a plurality of media types, a media coding parameter stored in memory and used in a new transmission source terminal is supplied to a reception terminal.

Accordingly, it is possible for the reception terminal to perform media decoding when a media coded signal transmitted thereto is changed.

### BRIEF DESCRIPTION OF THE DRAWINGS

FIG. 1 shows a construction of a multimedia communication system that includes a communication service unit according to a first embodiment, a third embodiment, a fourth embodiment or a sixth embodiment of the present invention.

FIG. 2 is a block diagram showing an internal construction of a communication service unit according to the first embodiment.

FIG. 3 shows a construction of a multimedia communication system that includes a communication service unit according to a second embodiment of the present invention.

FIG. 4 is a block diagram showing an internal construction of a communication service unit according to the second embodiment.

FIG. 5 shows an operation of a multimedia communication system according to the second embodiment.

FIG. 6 is a block diagram showing an internal construction of a communication service unit according to the third embodiment.

FIG. 7 is a block diagram showing an internal construction of a communication service unit according to the fourth embodiment and the sixth embodiment.

FIG. 8 shows a construction of a multimedia communication system that includes a communication service unit according to a fifth embodiment or a seventh embodiment of the present invention.

FIG. 9 is a block diagram showing an internal construction of the communication service unit according to the fifth embodiment or the seventh embodiment.

### BEST MODE OF CARRYING OUT THE INVENTION

The best mode of carrying out the invention will now be described with reference to the attached drawings.

First embodiment

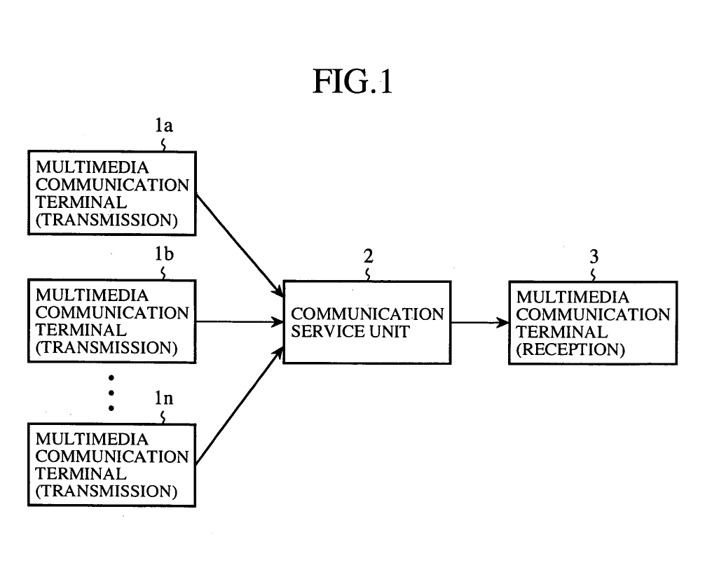

FIG. 1 shows a construction of a multimedia communication system that includes a communication service unit according to the first embodiment. Referring to FIG. 1, the system comprises multimedia communication terminals at the transmitting end (hereinafter, simply referred to as transmission terminals) 1a-1n, a communication service unit 2, and a multimedia communication terminal 3 at the receiving end (hereinafter, simply referred to as a reception terminal). FIG. 1 shows a construction of a multimedia communication system in which the communication service unit 2 selects multimedia information transmitted from a plurality of transmission terminals 1a-1n, demultiplexes the multimedia information into information of respective media types, processes the demultiplexed information as required, multiplexes the media information of a plurality of media types before transferring the multiplexed information to the reception terminal 3.

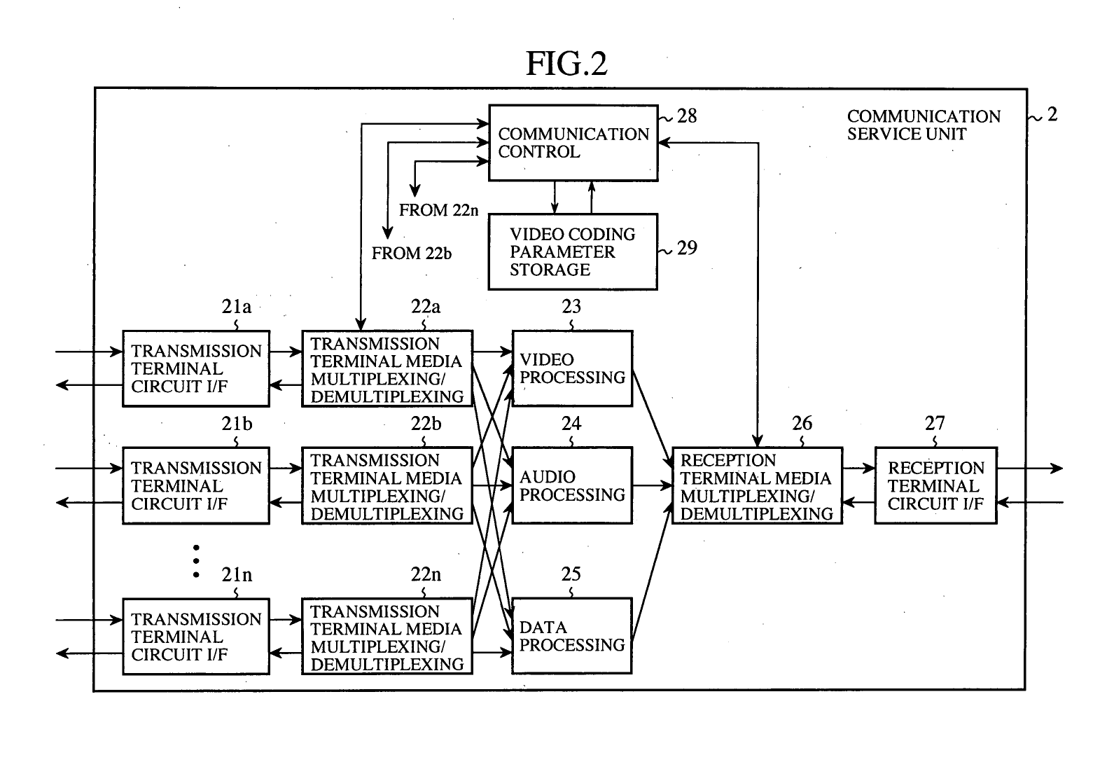

FIG. 2 is a block diagram showing an internal construction of the communication service unit 2 according to the first embodiment. Referring to FIG. 2, the communication service unit 2 comprises circuit interface (I/F) units 21a-21n interfacing transmission terminals, media multiplexing/demultiplexing units 22a-22n provided for transmission terminals, a video processing unit 23, an audio processing unit 24, a data processing unit 25, a media multiplexing/demultiplexing unit 26 provided for the reception terminal, a circuit I/F unit 27 interfacing the reception terminal, a communication control unit 28 and a video coding parameter storage unit 29. Aside from the functional units shown in the diagram, other components including a unit controller for controlling the communication service unit 2 are necessary. However, these components do not have direct relevance to the present invention so that the description and illustration thereof are omitted. Signals transmitted in directions opposite to the illustrated directions may be present between the transmission terminal media multiplexing/demultiplexing units 22a-22n and the units 23, 24, 25. Also, signals transmitted in directions opposite to the illustrated directions may be present between the units 23, 24, 25 and the reception terminal media multiplexing/demultiplexing unit 26. These signals transmitted in the opposite directions do not have direct relevance to the present invention so that the illustration and description thereof are omitted.

A description will now be given of the operation according to the first embodiment.

More specifically, a description will be given of operations of the communication service unit 2 in the multimedia communication system according to the first embodiment. The communication service unit 2, receiving multimedia information from the plurality of transmission terminals 1a-1n, demultiplexes the multimedia information into media information of respective media types, selects the media information of a desired media type, processes the media information as required, multiplexes the information of a plurality of media types and transmits the multiplexed information to the reception terminal 3. Basically, the flow of signals between functional units is bidirectional. The description of those signals of the directions not related to the present invention will be omitted.

The transmission terminals 1a-1n shown in FIG. 1 employ, for example, MPEG4 as a method of encoding a video signal. Multimedia information is generated by multiplexing communication control information used for control of communication between terminals constituting the multimedia communication system, a video coded signal produced by encoding according to MPEG4, an audio coded signal produced by encoding according to an audio coding method, and user data. Multiplexing of signals and data is performed according to a multiplexing method such as ITU-T H.223. The multimedia information thus generated is transmitted to the communication service unit 2. According to ITU-T H.223, individual logical channels corresponding to respective information are established in a given physical channel for transfer of information.

The communication service unit 2 receives the multimedia information transmitted from the transmission terminals 1a-1n via the transmission terminal circuit I/F units 21a-21n. The communication service unit 2 subjects the multimedia information to a reception process adapted for a type of circuit used in communication before outputting the information to the transmission terminal media multiplexing/demultiplexing units 22a-22n.

The transmission terminal media multiplexing/demultiplexing units 22a-22n subject the multimedia information supplied by the transmission terminal circuit I/F units 21a-21n to a demultiplexing process for producing media information by demultiplexing. The media information (video, audio, data) thus produced by demultiplexing is output to the video processing unit 23, the audio processing unit 24 and the data processing unit 25 responsible for subjecting the respective media information to related processes. Communication control information is output to the communication control unit 28.

In accordance with an instruction from the unit controller (not shown), the video processing unit 23 examines video coded signals output from the transmission terminal media multiplexing/demultiplexing units 22a-22n to select a video coded signal to be transmitted to the reception terminal 3 and outputs the selected video coded signal to the reception terminal media multiplexing/demultiplexing unit 26.

In accordance with an instruction from the unit controller (not shown), the audio processing unit 24 subjects an audio coded signal supplied by the transmission terminal media multiplexing/demultiplexing units 22a-22n to a mixing process and a re-encoding process after selection and decoding. The audio coded signal thus processed is output to the reception terminal media multiplexing/demultiplexing unit 26.

In accordance with an instruction from the unit controller (not shown), the data processing unit 25 subjects a data signal supplied by the transmission terminal media multiplexing/demultiplexing units 22a-22n to selection and a predetermined process. The data signal thus processed is output to the reception terminal media multiplexing/demultiplexing unit 26.

The communication controller 28 receives communication control information isolated from the multimedia information by the transmission terminal media multiplexing/demultiplexing units 22a-22n, and analyzes the communication control information so as to extract video coding parameters and output the same to the video coding parameter storage unit 29. The video coding parameter (media coding parameter) is included in a message transmitted from each of the transmission terminals 1a-1n to establish a video logical channel.

The video coding parameter storage unit 29 stores video coding parameters supplied by the communication control unit 28 and corresponding to video coded signals from the transmission terminals 1a-1n. In accordance with an instruction from the unit controller (not shown), the video coding parameter storage unit 29 supply to the communication control unit 28 the video coding parameter for the video coded signal from the transmission terminal (1a-1n) selected for connection as a source of supply to the reception terminal 3.

The communication control unit 28 reads the video coded parameter stored in the video coding parameter storage unit 29 and outputs the same to the reception terminal multiplexing/demultiplexing unit 26 on a continuous basis or when the transmission of the video coded signal is started or when the source of transmission of the video coded signal is changed.

The reception terminal media multiplexing/demultiplexing unit 26 multiplexes the media information (video information, audio information and data) supplied by the video processing unit 23, the audio processing unit 24 and the data processing unit 25, and the communication control information from the communication control unit 28 so as to output the multiplexed information to the reception terminal circuit I/F unit 27.

The reception terminal circuit I/F unit 27 subjects the multiplexed information to a process adapted for a type of circuit used in communication so as to output the resultant information to the reception terminal 3.

Thus, when the communication service unit 2 starts the transmission of the video coded signal or when the source of transmission of the video coded signal is changed, the video coding parameter corresponding to the video coded signal from the transmission terminal (1a-1n) selected for connection as a source of supply to the reception terminal 3 is transmitted to the reception terminal 3 as the communication control information. The communication control information is transmitted from the communication service unit 2 to the reception terminal 3 on a continuous basis or at predetermined periods via the logical channel for communication control.

In a similar configuration as the transmission terminals 1a-1n, the reception terminal 3 employs MPEG4. A method complying with ITU-T H. 223 is employed as a media demultiplexing method. The multiplexed signals transmitted from the transmission terminals 1a-1n via the communication service unit 2 are subject to a media demultiplexing process. Subsequently, processes including a decoding process corresponding to respective media types are performed in accordance with the communication control information before a predetermined output operation is performed.

A description will now be given, by taking an example of video coded signal, the operation performed when the transmission of the video coded signal from the communication service unit 2 to the reception terminal 3 is started, or when the source of transmission is changed.

When the transmission of the video coded signal to the reception terminal 3 is started or when the source of transmission is changed, the communication control unit 28 of the communication service unit 2 performs, in accordance with an instruction from the unit controller (not shown), exchanges messages via a control logical channel with the communication control unit (not shown) of the reception terminal 3 to establish a video logical channel (when the source of transmission is changed, the logical channel already established is disconnected and a new logical channel is established). The communication control unit 28 reads, from the video coded parameter storage unit 29, the video coded parameter used in the newly connected transmission terminal or the transmission terminal which is a new source of transmission. The video coding parameter thus read is added to a message for establishing or re-establishing a video logical channel. The communication control unit 28 exchanges resultant messages with the reception terminal 3 via the control logical channel or the like.

When the establishment of the video logical channel is determined as a result of exchange of messages with the reception terminal 3, the communication control unit 28 outputs the communication control information for establishing the video logical channel to the reception terminal media multiplexing/demultiplexing unit 26.

The reception media multiplexing/demultiplexing unit 26 establishes or re-establishes the video logical channel, based on the communication control information provided by the communication control unit 28 to direct the video logical channel to be established. The reception terminal media multiplexing/demultiplexing unit 26 receives via the video processing unit 23 the video coded signal from the terminal which is a new source of transmission of the video coded signal. The reception terminal multiplexing/demultiplexing unit 26 multiplexes the video coded signal with other media information so as to transmit the multiplexed information to the reception terminal 3 via the reception terminal circuit I/F unit 27.

The reception terminal 3 decodes the video coded signal received via the video logical channel, based on the video coding parameter included in the message for establishing the video logical channel received via the control logical channel.

In the description above of the first embodiment, the operation of the transmission terminal 1a-1n is described as being separate from the operation of the reception terminal 3 for simplicity of the description. However, the invention according to the first embodiment is also applicable to a system such as a multimedia communication system of the second embodiment described later, where each of the communication terminals 1a-1n are capable of bidirectional communication, i.e. capable of simultaneous transmission and reception, by allowing units constituting the system to be adapted for both transmission and reception.

In the above, the invention according to the first embodiment is described as being applicable to the operation performed when the communication service unit 2 starts the transmission of the video coded signal to the reception terminal 3 or when the source of transmission of the video coded signal is changed. Application of the invention according to the first embodiment is not limited to such operations. The invention is equally applicable to the operation performed when the transmission of an audio coded signal is started, when the source of transmission of the audio coded signal is changed, when the transmission of a data coded signal is started, when the source of transmission of the data coded signal is changed, when the transmission of multimedia information comprising a mixture of media information is started, or when the source of transmission of the multimedia information is changed. The width of application described above equally applies to the subsequent embodiments described hereinafter.

Thus, according to the first embodiment, the communication service unit 2 stores video coding parameters transmitted from the entirety of the transmission terminals 1a-1n. When the transmission of the video coded signal to the reception terminal 3 is started or when the source of transmission of the video coded signal is changed, the video coding parameter used in the new transmission source terminal is added to the message transmitted via the control logical channel to establish or reestablish the video logical channel. With this, the reception terminal 3 is notified of the video coding parameter used in the new transmission source terminal. Therefore, the reception terminal 3 is capable of performing the process of decoding the video coded signal efficiently when the transmission of the video coded signal is started or when the source of transmission of the video coded signal is changed.

Second embodiment

The second embodiment is a variation from the first embodiment in that the entirety of transmission multimedia communication terminals 1a-1n constituting the multimedia communication system of the first embodiment are capable of bidirectional communication, i.e. simultaneous transmission and reception.

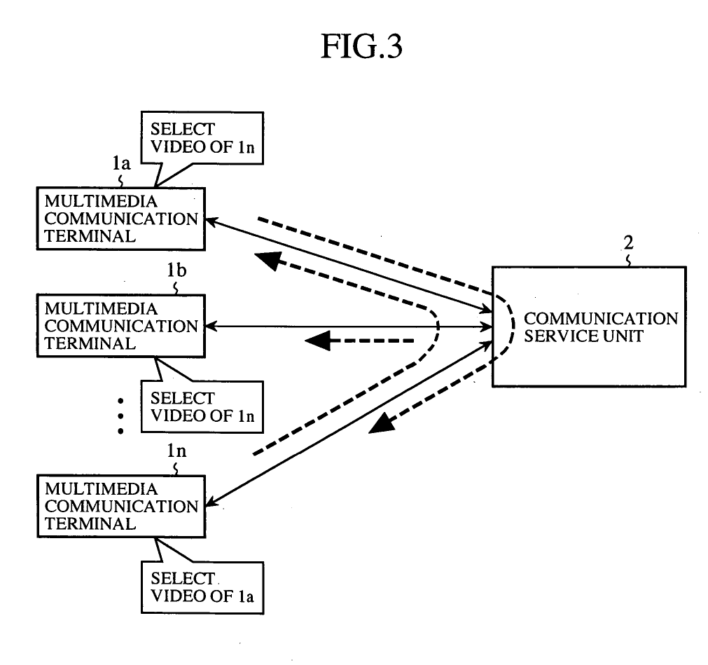

FIG. 3 shows a construction of a multimedia communication system that includes a communication service unit according to the second embodiment. Those components identical with or corresponding to the components of the multimedia communication system shown in FIG. 1 are designated by the same reference numerals and symbols so that the description thereof is omitted. FIG. 3 shows a system for transmission and reception of media information including video, audio and data, where the multimedia communication terminals (hereinafter, referred to as communication terminals) 1a-1n perform bidirectional communication via the communication service unit 2.

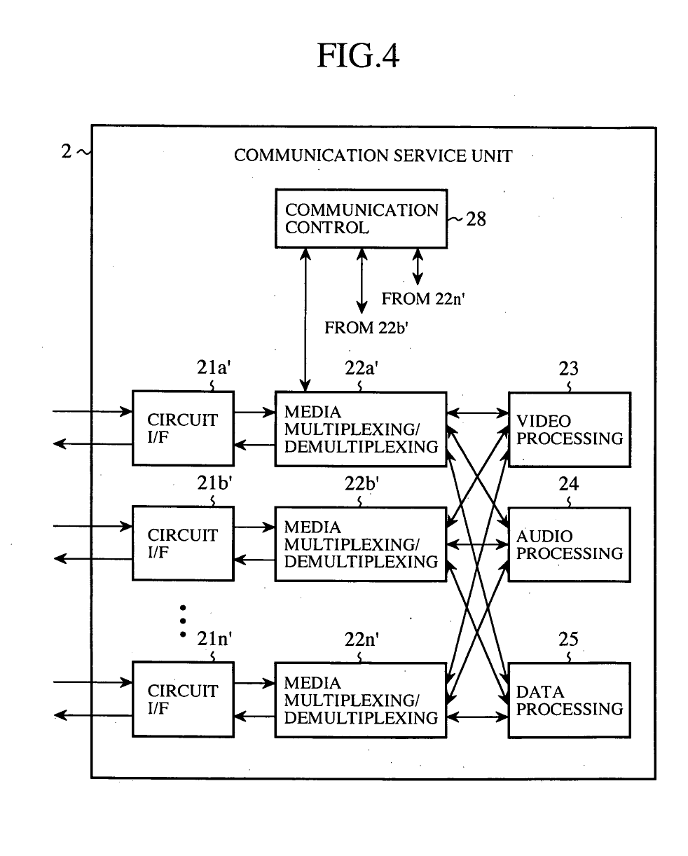

FIG. 4 is a block diagram showing an internal construction of the communication service unit 2 according to the second embodiment. Referring to FIG. 4, the communication service unit 2 comprises circuit I/F units 21a′-21n′, media multiplexing/demultiplexing units 22a′-22n′, a video processing unit 23, an audio processing unit 24, a data processing unit 25 and a communication control unit 26.

A description will now be given of the operation according to the second embodiment.

The operations performed by the multimedia communication system according to the second embodiment are similar to those of the system according to the first embodiment except that the communication terminals and the like constituting the system are capable of both transmission and reception. Accordingly, the description below mainly concerns the communication control unit 28 constituting the communication service unit 2 and performing operations characteristic to the multimedia communication system according to the second embodiment. The description of the operations of the functional units similar to those of the multimedia communication system according to the first embodiment is omitted.

In a similar configuration as the communication service unit 2 of the first embodiment, the communication service unit 2 of the second embodiment exchanges messages with the communication control unit (not shown) of the reception communication terminals 1a-1n via a control logical channel, in accordance with an instruction from the unit controller (not shown), when the transmission of the video coded signal to the reception communication terminal is started, or when the source of transmission of the video coded signal is changed. The communication service unit 2 establishes a video logical channel or reestablishes a video logical channel by first disconnecting the current logical channel so as to change the source of transmission. The communication service unit 2 then adds the video coding parameter used in the new transmission source terminal to a message for establishing a logical channel and transmits the resultant message to the reception communication terminals 1a-1n.

In accordance with an instruction from the unit controller (not shown), the communication control unit 28 of the communication service unit 2 exchanges messages with the communication terminals 1a-1n via the control logical channel, when the communication with the communication terminals lain is started or when the source of transmission of the video coded signal is changed. With this, the capabilities of the terminals are known through negotiation.

The communication control unit 28 directs each of the communication terminals 1a-1n to establish a video logical channel for transferring the video coded signal as a set of two unidirectional logical channels of opposite directions each subject to independent management, instead of a bidirectional logical channel subject to uniform management. The phrase “the entirety of the communication terminals 1a-1n”, directed to establish unidirectional logical channels, refer to all of the communication terminals covered by a multi-point communication service, in a case in which the communication service unit 2 provides a multi-point communication service available between a plurality of communication terminals. More specifically, it refers to all of the communication terminals constituting a given group covered by the multi-point communication service and does not include in its reference those communication terminals not related to the group covered by the multi-point communication service.

The communication terminals 1a-1n directed by the communication service unit 2 to establish unidirectional logical channels establish unidirectional logical channels for transfer of the video coded signal, in accordance with an instruction from the communication service unit 2. The communication service unit 2 also establishes unidirectional logical channels with the communication terminals 1a-1n for transfer of the video coded signal. Thus, the logical channels for transfer of the video coded signal are all established as unidirectional logical channels. Therefore, the operation of the multimedia communication system according to the second embodiment is similar to the operation of the multimedia communication system according to the first embodiment using unidirectional channels.

A description will now be given of the operation of the communication service unit 2 by illustrating a case where the source of transmission of the video coded signal received by the communication terminal 1a is changed.

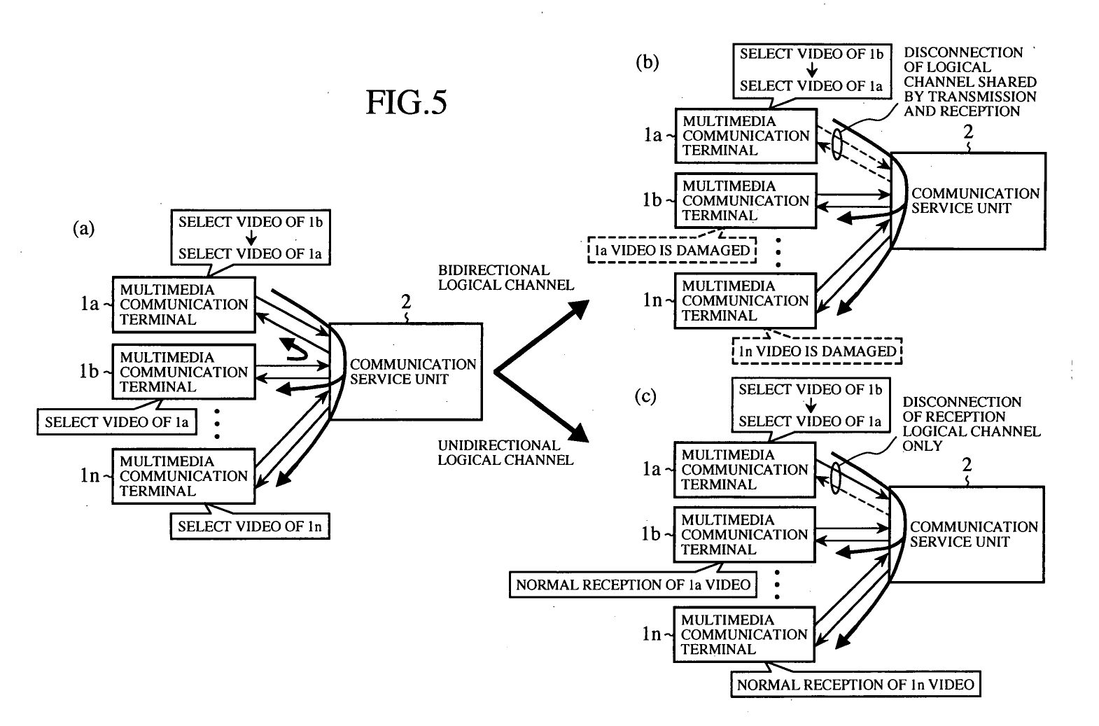

FIG. 5 shows an operation of a multimedia communication system according to the second embodiment. Those components that are identical with the components of the multimedia communication system shown in FIG. 3 are designated by the same reference numerals and symbols so that the description thereof is omitted.

A similar operation as illustrated in FIG. 5 is performed when the transmission of the video coded signal to the receiving communication terminals 1a-1n is started.

In the multimedia communication system shown in FIG. 5(a), the communication terminal 1a receives the video coded signal transmitted from the communication terminal 1b selected by the communication service unit 2. The video coded signal is decoded in the communication terminal 1a for display. The communication terminals 1b and 1n receive the video coded signal transmitted from the communication terminal 1a selected by the communication service unit 2. The video coded signal is decoded in the communication terminals 1b and 1n for display. The communication terminals lain establish logical channels for transmission and reception via the communication service unit 2.

When the communication service unit 2 changes the source of transmission of the video coded signal to the communication terminal 1a from the communication terminal 1b to the communication terminal in, the communication service unit 2 and the communication terminal 1a exchange messages via the control logical channel so as to disconnect and re-establish the video logical channel. The communication service unit 2 adds the video coding parameter stored in the communication service unit 2 and used in the new transmission source terminal (i.e. the communication terminal in), to a message for establishing a video logical channel. The communication unit 2 transmits the resultant message to the communication terminal 1a.

With this, the communication terminal 1a is capable of knowing the video coding parameter used in the new transmission source terminal without delay, when the source of transmission of the video coded signal is changed from the communication terminal 1b to the communication terminal 1n. Accordingly, the process of decoding the video coded signal is performed efficiently.

As shown in FIG. 5(b), if the video logical channel for transfer of the video coded signal between the communication terminal 1a and the communication service unit 2 is a bidirectional logical channel, disconnection of the video logical channel results in not only the logical channel for transfer from the communication service 2 to the communication terminal 1a being disconnected but also the logical channel for transfer in the opposite direction from the communication terminal 1a to the communication service unit 2 being disconnected. As a result, decoding for display of the video coded signal from the communication terminal 1a in the communication terminals 1b and 1n as well as other terminals is damaged.

In order to avoid this failure, as shown in FIG. 5(c), bidirectional communication is enabled in the communication terminals 1a-1n according to the second embodiment by establishing unidirectional logical channels of opposite directions. For example, when the transmission of the video coded signal to the communication terminal 1a is started, or when the source of transmission of the video coded signal thereto is changed, the communication service unit 2 only disconnects the unidirectional logical channel for transfer from the communication service unit 2 to the communication terminal 1a before establishing or re-establishing the target channel. The unidirectional channel of the opposite direction for transfer from the communication terminal 1a to the communication service unit 2 is not disconnected. With this, the communication terminals 1b and in as well as other communication terminals continue to properly decode the video coded signal transmitted from the communication terminal 1a.

In the above, the invention according to the second embodiment is described as being applicable to the operation performed when the transmission of the video coded signal to the reception communication terminals 1a-1n is started or when the source of transmission of the video coded signal is changed. Application of the invention according to the second embodiment is not limited to such operations. The invention is equally applicable to the operation performed when the transmission of an audio coded signal is started, when the source of transmission of the audio coded signal is changed, when the transmission of a data coded signal is started, when the source of transmission of the data coded signal is changed, when the transmission of multimedia information comprising a mixture of media information is started, or when the source of transmission of the multimedia information is changed. The width of application described above equally applies to the subsequent embodiments described hereinafter.

In the description of the second embodiment, it is assumed that unidirectional logical channels are used for transmission and reception so that the transmission and reception according to H.223 are subject to independent management, and establishment and disconnection are performed independent of each other. Logical channels for transfer of the video coded signal to the entirety of the communication terminals 1a-1n are established as unidirectional logical channels, when the transmission of the video coded signal to the reception communication terminal 1a is started or when the source of transmission of the video coded signal is changed. Application of the invention according to the second embodiment is not limited to such operations. For example, the invention is equally applicable to an arrangement where unidirectional logical channels are not used. More specifically, when the communication terminal 1a, transmitting one video coded signal while receiving another as shown in FIG. 3, changes the source of transmission of the video coded signal that it is receiving, only the logical channel established in the communication terminal 1a for reception of the video coded signal may be disconnected for subsequent re-establishment of a new logical channel and may maintain the logical channel for transmission of the video coded signal therefrom. With this, bidirectional communication in the multi-point communication service available in the communication terminals 1b-1n is not blocked so that the communication terminals 1b-1n can continue to decode the video coded signal properly.

As described above, according to the second embodiment, by establishing logical channels between the communication terminals 1a-1n and the communication service unit 2 as unidirectional logical channels, the communication terminals 1b and 1n, receiving for decoding the video coded signal transferred in the logical channel, of a direction in which transfer from the communication terminal 1a to the communication service unit 2 occurs, can continue to decode the video coded signal properly, when the transmission of the video coded signal from the communication terminal 1a capable of bidirectional communication is started, or when the source of transmission of the video coded signal being received by the communication terminal 1a is changed.

Third embodiment

The construction of a multimedia communication system according to the third embodiment is similar to the system according to the first embodiment so that the numerals and symbols used in FIG. 1 are used in the description below.

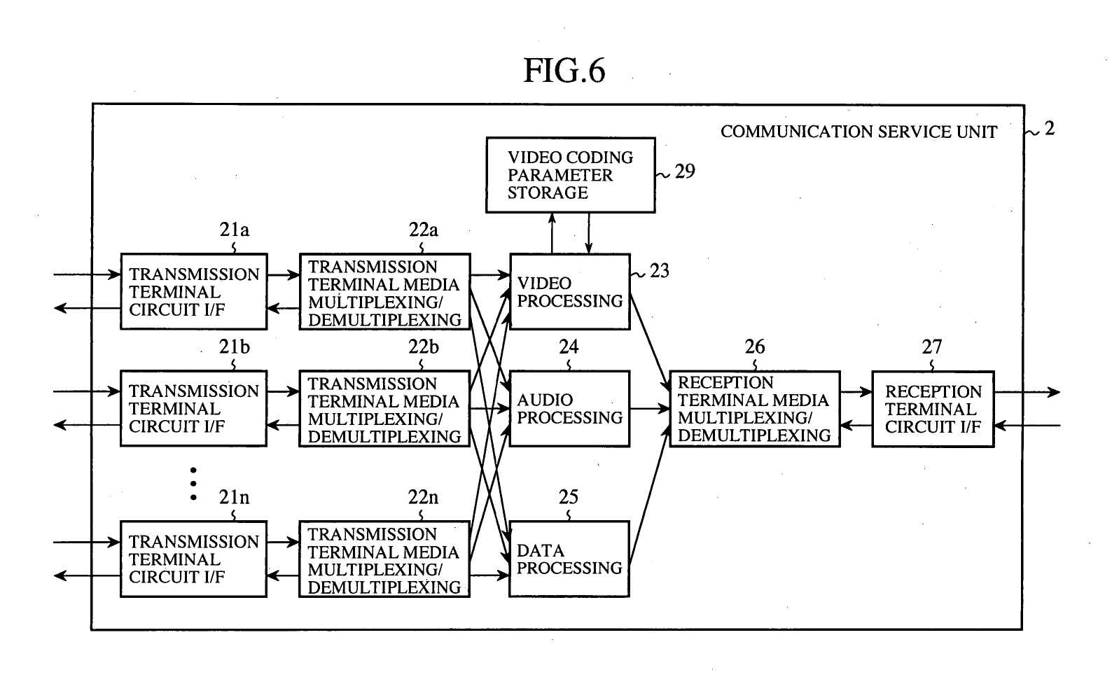

FIG. 6 is a block diagram showing an internal construction of the communication service unit 2 according to the third embodiment. Those components that are identical with or corresponding to the components of the communication service unit 2 shown in FIG. 2 are designated by the same numerals and symbols so that the description thereof is omitted. The functional units constituting the communication service unit 2 shown in FIG. 6 are identical with the components shown in FIG. 2 and provide the same function and effects. While illustration of the communication control unit 28 is omitted in FIG. 6, the communication service unit 2 according to the third embodiment is also provided with the communication control unit 28. Aside from the functional units shown in this diagram, other components including a unit controller for controlling the communication service unit and a communication control unit are necessary. However, these components do not have direct relevance to the present invention so that the description and illustration thereof is omitted. Signals transmitted in directions opposite to the illustrated directions may be present between the transmission terminal media multiplexing/demultiplexing units 22a-22n and the units 23, 24, 25. Also, signals transmitted in directions opposite to the illustrated directions may be present between the units 23, 24, 25 and the reception terminal media multiplexing/demultiplexing unit 26. These signals transmitted in the opposite directions do not have direct relevance to the present invention so that the illustration and description thereof are omitted.

A description will now be given of the operation according to the third embodiment.

The video coding parameter storage unit 29 of the communication service unit 2 according to the third embodiment stores video coding parameters corresponding to the video coded signals transmitted from the communication terminals 1a-1n. When the transmission of the video coded signal to the reception terminal 3 is started, or when the source of transmission of the video coded signal is changed, the communication service unit 2 notifies the reception terminal 3 of the video coding parameter thus stored and used in the communication terminal (1a-1n) which is a new source of transmission. This operation of notification is the same as that of the communication service unit 2 of the first embodiment. Description of operations that are similar to those of the first embodiment is omitted. The operations characteristic to the communication service unit 2 according to the third embodiment, i.e. the operations of the video processing unit 23 and the video coding parameter storage unit 29, will be described.

The video processing unit 23 provided in the communication service unit 2 according to the third embodiment extracts the video coding parameter set at the head of the video coded signal from each of the transmission terminal media multiplexing/demultiplexing units 22a-22n so as to output the extracted parameter to the video coding parameter storage unit 29.

The video coding parameter storage unit 29 stores the video coding parameter supplied by the video processing unit 23 and corresponding to the video coded signal transmitted by each of the transmission communication terminals 1a-1n. In accordance with an instruction from the unit controller (not shown), the video coding parameter used in the new transmission source terminal (1a-1n) is read out and output to the video processing unit 23, when the transmission of the video coded signal to the reception terminal 3 is started or when the source of transmission of the video coded signal is changed.

In accordance with an instruction from the unit controller (not shown), the video processing unit 23 selects the video coded signal to be transmitted to the reception terminal 3. The video processing unit 23 multiplexes the video coding parameter read out from the video coding parameter storage unit 29 in the video coded signal so as to output the resultant signal to the reception terminal media multiplexing/demultiplexing unit 26.

The reception terminal 3 uses the video coding parameter multiplexed in the video coded signal to decode the video coded signal.

In the description above of the third embodiment, the operation of the transmission terminals 1a-1n is described as being separated from the operation of the reception terminal 3 for simplicity of the description. However, in a similar configuration as the multimedia communication system according to the second embodiment shown in FIG. 3, the communication terminals 1a-1n may be configured as terminals capable of both transmission and reception to provide the same functions and effects.

The communication service unit 2 according to the third embodiment is described as being configured such that the video processing unit 23 directly stores the video coding parameter in the video coding parameter storage unit 29. Application of the present invention is not limited to this arrangement. In a similar configuration as the communication service unit 2 according to the first embodiment shown in FIG. 2, the communication control unit 28 may extract the video coding parameters from the media multiplexing/demultiplexing units 22a-22n and write the extracted parameters in the video coding parameter storage unit 29.

Thus, according to the third embodiment, the video coding parameters output from the entirety of the communication terminals 1a-1n are stored in the communication service unit 2. When the transmission of the video coded signal to the reception terminal 3 is started or when the source of transmission of the video coded signal is changed, the reception terminal 3 is notified of the video coding parameter used in the new transmission source terminal by multiplexing the parameter in the video coded signal. Accordingly, the reception terminal 3 is capable of decoding the video coded signal efficiently when the transmission of the video coded signal is started or when the source of transmission of the video coded signal is changed.

Fourth Embodiment

The construction of a multimedia communication system according to the fourth embodiment is similar to the system according to the first embodiment shown in FIG. 1 so that the numerals and symbols used in FIG. 1 are used in the description below.

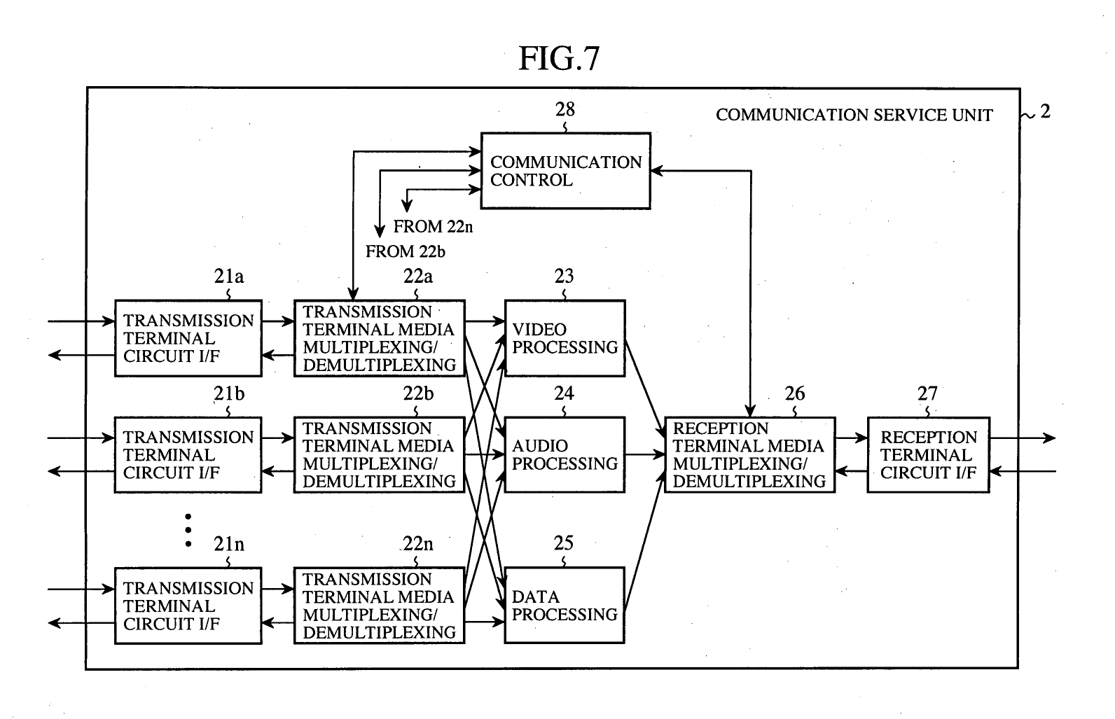

FIG. 7 is a block diagram showing an internal construction of the communication service unit 2 according to the fourth embodiment. The communication service unit 2 shown in FIG. 7 is constructed such that the video coding parameter storage unit 29 is eliminated from the communication service unit 2 shown in FIG. 2. The other aspects of the construction remain the same. In FIG. 7, those components that are identical with the components shown in FIG. 2 are designated by the same numerals and symbols so that the description thereof is omitted.

The multimedia communication system according to the fourth embodiment is configured such that the communication terminals 1a-1n use a single video coding parameter when the communication is started. Aside from the functional units shown in this diagram, other components including a unit controller for controlling the communication service unit are necessary. However, these components do not have direct relevance to the present invention so that the description and illustration are omitted. Signals transmitted in directions opposite to the illustrated directions may be present between the transmission terminal media multiplexing/demultiplexing units 22a-22n and the units 23, 24, 25. Also, signals transmitted in directions opposite to the illustrated directions may be present between the units 23, 24, 25 and the reception terminal media multiplexing/demultiplexing unit 26. These signals transmitted in the opposite directions do not have direct relevance to the present invention so that the illustration and description thereof are omitted.

A description will now be given of the operation according to the fourth embodiment.

A majority of the functional units constituting the communication service unit 2 according to the fourth embodiment perform similar operations as the units constituting the communication service unit 2 according to the first embodiment so that the description thereof is omitted. Those operations characteristic to the communication service unit 2 according to the fourth embodiment will be described, focusing on the operation of the communication control unit 28.

In accordance with an instruction from the unit controller (not shown), the communication control unit 28 of the communication service unit 2 according to the fourth embodiment exchanges messages with the transmission communication terminals 1a-1n and with the reception terminal 3 via the control logical channel, when the communication is started. With this, the capabilities of the terminals are known through negotiation.

The communication control unit 28 selects at least one video coding parameter that the reception terminal 3 may use for decoding and the entirety of the transmission terminals 1a-1n may use for coding. The communication control unit 28 directs the entirety of the transmission terminals 1a-1n to use the selected common video coding parameter. In a similar configuration as the second embodiment, the phrase “the entirety of the communication terminals 1a-1n” refer to all of the communication terminals covered by a multi-point communication service, in a case in which the communication service unit 2 provides a multi-point communication service available between a plurality of communication terminals. More specifically, it refers to all of the communication terminals constituting a given group covered by the multi-point communication service and does not include in its reference those communication terminals not related to the group covered by the multi-point communication service.

By employing the video coding parameter requested by the communication service unit 2 in the transmission terminals 1a-1n, the video coded signals transmitted from the entirety of the transmission terminals 1a-1n to the communication service unit 2 are processed using the common video coding parameter.

A stream transmitted from the transmission terminals 1a-1n is input to the communication service unit 2. The transmission terminal circuit I/F units 21a-21n corresponding to the transmission terminals 1a-1n, and the transmission terminal media multiplexing/demultiplexing units 22a-22n receive multimedia information and demultiplexes the multimedia information to produce media information. The media information is then input to the video processing unit 23, the audio processing unit 24 and the data processing unit 25.

The video processing unit 23 selects, from the video coded signals supplied from the transmission terminal media multiplexing/demultiplexing units 22a-22n, the video coded signal to be transmitted to the reception terminal 3, based on an instruction from the unit controller (not shown). The selected video coded signal is then output to the reception terminal media multiplexing/demultiplexing unit 26.

The media information is then processed in the reception terminal media multiplexing/demultiplexing unit 26 and the reception terminal circuit I/F unit 27, before being transmitted to the reception terminal 3.

As a result of capability negotiation via the control logical channel with the communication service unit 2 performed when the communication is started, the reception terminal 3 performs a process of decoding the video coded signal using the video coding parameter requested by the communication service unit 2. Processes related to the other media information are performed in a manner similar to the first embodiment. A description thereof is omitted since they do not have direct relevance to the invention according to the fourth embodiment.

In the above description of the fourth embodiment, the operation of the transmission terminals 1a-1n is described as being separate from the operation of the reception terminal 3. However, in a similar configuration as the multimedia communication system according to the second embodiment shown in FIG. 3, the communication terminals 1a-1n may be configured as communication terminals capable of both transmission and reception to provide the same functions and effects.

In the above, the communication service unit 2 is described as exchanging messages for capability negotiation, via the control logical channel, with the transmission terminals 1a-1n and with the reception terminal 3 when the communication is started. Application of the invention according to the fourth embodiment is not limited to this arrangement. The fourth embodiment is equally applicable when the transmission of voice, data or multimedia information which is a mixture of these is started or the source of transmission thereof is changed.

As described above, according to the fourth embodiment, the communication service unit 2 exchanges capability negotiation messages via the control logical channel with the transmission terminals 1a-1n and with the reception terminal 3 when the communication is started. The communication service unit 2 determines the video coding parameter that the reception terminal 3 may use for decoding and the transmission terminals lain may use for coding. The video coding parameter thus determined is provided for use to the transmission terminals 1a-1n and the reception terminal 3. Accordingly, it is ensured that the entirety of the transmission terminals 1a-1n and the reception terminal 3 use the same video coding parameter. The reception terminal 3 is capable of decoding the vide coded signal efficiently when the transmission of the video coded signal is started or when the source of transmission of the video coded signal is changed.

Fifth Embodiment

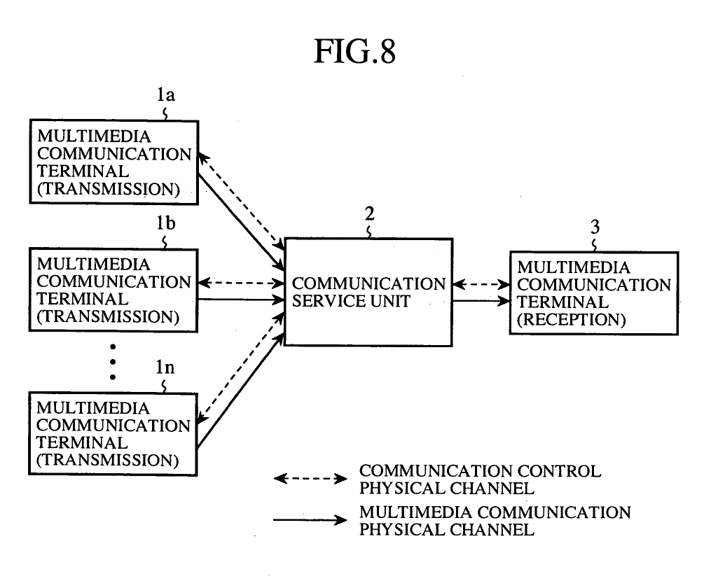

FIG. 8 shows a construction of a multimedia communication system that includes a communication service unit according to the fifth embodiment. Similar to the multimedia communication system according to the first embodiment shown in FIG. 1, the multimedia communication system shown in FIG. 8 is configured such that the communication service unit 2 selects desired multimedia information from multimedia information transmitted by a plurality of transmission terminals 1a-1n. The multimedia information is demultiplexed into media information and subsequently processed as required. The media information is multiplexed again before being transferred to the reception terminal 3.

The multimedia information system of FIG. 8 is essentially the same as the multimedia information system of FIG. 1 except that communication channels indicated by broken lines are provided for communication control aside from the communication channels used for transmission of multimedia information. The communication channels indicated by broken lines carry independent calls and are provided between the transmission terminals 1a-1n and the communication service unit 2 and between the communication service unit 2 and the reception terminal 3. Signals transmitted in directions opposite to the illustrated directions may be present between the transmission terminal media multiplexing/demultiplexing units 22a-22n and the units 23, 24, 25. Also, signals transmitted in directions opposite to the illustrated directions may be present between the units 23, 24, 25 and the reception terminal media multiplexing/demultiplexing unit 26. These signals transmitted in the opposite directions do not have direct relevance to the present invention so that the illustration and description thereof are omitted.

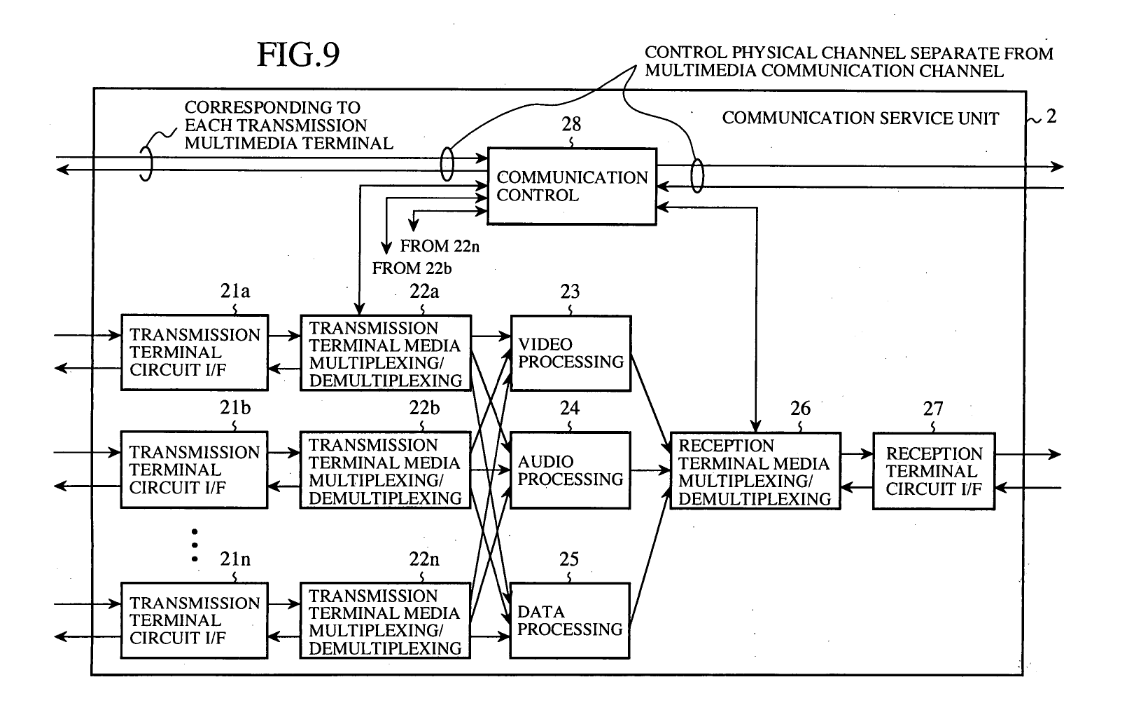

FIG. 9 is a block diagram showing an internal construction of the communication service unit 2 according to the fifth embodiment. The construction of the communication service unit 2 is similar to the construction of the unit shown in FIG. 2. In FIG. 9, those components that are identical with the corresponding components shown in FIG. 2 are designated by the same numerals and symbols so that the description thereof is omitted.

Aside from the functional units shown in FIG. 9, other components including a unit controller for controlling the communication service unit are necessary. However, these components do not have direct relevance to the present invention so that the description and illustration are omitted. Signals transmitted in directions opposite to the illustrated directions may be present between the transmission terminal media multiplexing/demultiplexing units 22a-22n and the units 23, 24, 25. Also, signals transmitted in directions opposite to the illustrated directions may be present between the units 23, 24, 25 and the reception terminal media multiplexing/demultiplexing unit 26. These signals transmitted in the opposite directions do not have direct relevance to the present invention so that the illustration and description thereof are omitted.

A description will now be given of the operation according to the fifth embodiment.

In a similar configuration as the multimedia communication system according to the fourth embodiment, the system according to the fifth embodiment operates such that the communication service unit 2 exchanges capability negotiation messages with the transmission terminals 1a-1n and with the reception terminal 3 when the communication is started so that the same video coding parameter is used throughout the system. A majority of the functional units constituting the communication service unit 2 according to the fifth embodiment perform the same operations as those of the communication service unit 2 according to the fourth embodiment so that the description thereof is omitted. The operation characteristic to the communication service unit 2 according to the fifth embodiment, i.e. the operation of the communication control unit 28, will be described.

In accordance with an instruction from the unit controller (not shown), the communication control unit 28 of the communication service unit 2 according to the fifth embodiment uses the communication channels (the communication control physical channel indicated by broken lines in FIG. 8) carrying calls independent of the calls on the communication channels for multimedia communication to exchange capability negotiation messages with the transmission terminals 1a-1n and with the reception terminal 3 when the communication is started. The video coding parameter used in the entirety of the transmission terminals 1a-1n and the reception terminal 3 is determined so that the terminals are directed to use the common video coding parameter thus determined. In a similar configuration as the second and fourth embodiments, the phrase “the entirety of the communication terminals 1a-1n” refer to all of the communication terminals covered by a multi-point communication service, in a case in which the communication service unit 2 provides a multi-point communication service available between a plurality of communication terminals. More specifically, it refers to all of the communication terminals constituting a given group covered by the multi-point communication service and does not include in its reference those communication terminals not related to the group covered by the multi-point communication service.

In the fifth embodiment, the communication channels (communication control physical channels indicated by broken lines of FIG. 8) carrying independent calls are provided aside from the physical channels for multimedia communication. These channels are used as communication control channels in exchanging messages for capability negotiation. As a result, extra communication charge is incurred due to the communication channels carrying independent calls. By providing the communication control channels aside from the multimedia communication physical channels, however, restriction on bandwidth and adverse effect due to communication operations are eliminated.

By employing the video coding parameter requested by the communication service unit 2 in the transmission terminals 1a-1n and the reception terminal 3, the video coded signal transmitted from the entirety of the transmission terminals 1a-1n to the communication service unit 2 are processed using the common video coding parameter.

In the description above of the fifth embodiment, the communication service unit 2 is described as using the communication control channels carrying independent calls so as to request the transmission terminals 1a-1n and the reception terminal 3 to use the designated video coding parameter. Alternatively, a user may manually request the communication terminals 1a-1n and the reception terminal 3 to use a video coding method (for example, a method complying with the ITU-T Recommendation H.263) that uniquely determines a video coding parameter that the reception terminal 3 may use for decoding and the transmission terminals 1a-1n may use for coding. The request may or may not be transmitted via the communication service unit 2.

In the above description of the fifth embodiment, the operation of the transmission terminals 1a-1n is described as being separate from the operation of the reception terminal 3. However, in a similar configuration as the multimedia communication system according to the second embodiment shown in FIG. 3, the communication terminals 1a-1n may be configured as communication terminals capable of both transmission and reception to provide the same functions and effects. In this case, a difference from FIG. 3 is that the communication control channels carrying independent calls are available to the communication terminals 1a-1n in addition to the physical channels for transfer of the multimedia signal to and from the communication service unit 2 (communication channels indicated by solid lines in FIG. 3). The communication terminals 1a-1n use these independent channels to exchange messages for capability negotiation.

As described, according to the fifth embodiment, the communication channels carrying calls independent of the calls on the communication channels for multimedia communication are provided between the communication service unit 2 and the transmission terminals 1a-1n and between the communication service unit 2 and the reception terminal 3. The video coding parameter that the reception terminal 3 may use for decoding and the transmission terminals 1a-1n may use for coding is supplied by the communication service unit 2 to the respective terminals. The parameter may be supplied to the terminals by performing capability negotiation when the communication is started, using the independent communication control channels. Alternatively, the parameter may be supplied through the user's manual setting. Accordingly, it is ensured that the entirety of the transmission terminals 1a-1n and the reception terminal 3 use the same video coding parameter. The reception terminal 3 is capable of decoding the video coded signal efficiently when the transmission of the video coded signal is started or when the source of transmission of the video coded signal is changed.

Sixth Embodiment

The construction of the multimedia communication system according to the sixth embodiment is the same as that of the system according to the first embodiment shown in FIG. 1. The internal construction of the communication service unit 2 according to the sixth embodiment is the same as the construction according to the fourth embodiment shown in FIG. 7. In the following description, the same numerals and symbols as used in FIG. 1 and FIG. 7 will be used. Signals transmitted in directions opposite to the illustrated directions may be present between the transmission terminal media multiplexing/demultiplexing units 22a-22n and the units 23, 24, 25. Also, signals transmitted in directions opposite to the illustrated directions may be present between the units 23, 24, 25 and the reception terminal media multiplexing/demultiplexing unit 26. These signals transmitted in the opposite directions do not have direct relevance to the present invention so that the illustration and description thereof are omitted.

The transmission terminals 1a-1n and the reception multimedia terminal 3 constituting the multimedia communication system according to the sixth embodiment are adapted to use not only MPEG4 but also a video coding method such as ITU-T H.263 that uniquely determines the video coding parameter.

A description will now be given of the operation according to the sixth embodiment.

In the sixth embodiment, a majority of the functional units constituting the communication service unit 2 perform the same operations as the units constituting the communication service unit 2 according to the first embodiment so that the description thereof is omitted. The operation characteristic to the communication service unit 2 according to the sixth embodiment, i.e. the operation of the communication control unit 28, will be described.

When the communication is started, the communication control unit 28 of the communication service unit 2 according to the sixth embodiment exchange messages via the control logical channel with the transmission terminals 1a-1n and with the reception terminal 3 for negotiation for capability, in accordance with an instruction from the unit controller (not shown).

The communication control unit 28 selects a video coding method (for example, a method conforming to ITU-T H.263) that uniquely determines a video coding parameter that the reception terminal 3 may use for decoding and the entirety of the transmission terminals 1a-1n may use for coding. The communication control unit 28 directs the transmission terminals 1a-1n to use the selected video coding method. In a similar configuration as the second, fourth and fifth embodiments, the phrase “the entirety of the communication terminals 1a-1n” refer to all of the communication terminals covered by a multi-point communication service, in a case in which the communication service unit 2 provides a multi-point communication service available between a plurality of communication terminals. More specifically, it refers to all of the communication terminals constituting a given group covered by the multi-point communication service and does not include in its reference those communication terminals not related to the group covered by the multi-point communication service.

By employing the video coding parameter (ITU-T H.263) requested by the communication service unit 2 in the transmission terminals 1a-1n, the video coded signals transmitted from the entirety of the transmission terminals 1a-1n to the communication service unit 2 are processed using the common video coding parameter uniquely determined by the video coding method.

A stream transmitted from the transmission terminals 1a-1n is input to the communication service unit 2. The transmission terminal circuit I/F units 21a-21n corresponding to the transmission terminals 1a-1n, and the transmission terminal media multiplexing/demultiplexing units 22a-22n receive multimedia information and demultiplexes the multimedia information to produce media information. The media information is then input to the video processing unit 23, the audio processing unit 24 and the data processing unit 25.

The video processing unit 23 selects, from the video coded signals supplied by the transmission terminal media multiplexing/demultiplexing units 22a-22n, the video coded signal to be transmitted to the reception terminal 3, based on an instruction from the unit controller (not shown). The selected video coded signal is then output to the reception terminal media multiplexing/demultiplexing unit 26.

The media information is then processed in the reception terminal media multiplexing/demultiplexing unit 26 and the reception terminal circuit I/F unit 27, before being transmitted to the reception terminal 3.

As a result of capability negotiation via the control logical channel with the communication service unit 2 performed when the communication is started, the reception terminal 3 performs a process of decoding the video coded signal using the video coding method (method complying with ITU-T H. 263) requested by the communication service unit 2. Processes related to the other media information are performed in a manner similar to the first embodiment. A description thereof is omitted since they do not have direct relevance to the invention according to the sixth embodiment.

In the above description of the sixth embodiment, the operation of the transmission terminals 1a-1n is described as being separate from the operation of the reception terminal 3. However, in a similar configuration as the multimedia communication system according to the second embodiment shown in FIG. 3, the communication terminals 1a-1n may be configured as terminals capable of both transmission and reception to provide the same functions and effects.

As described above, according to the sixth embodiment, the communication service unit 2 exchanges capability negotiation messages via the control logical channel with the transmission terminals 1a-1n and with the reception terminal 3 when the communication is started. The communication service unit 2 determines the video coding method (for example, ITU-T H.20.63) that uniquely determines the video coding parameter that the reception terminal 3 may use for decoding and the transmission terminals 1a-1n may use for coding. The video coding method thus determined is provided to all of the terminals for use. Accordingly, it is ensured that the entirety of the terminals use the same video coding parameter. The reception terminal 3 is capable of decoding the video coded signal efficiently when the transmission of the video coded signal is started or when the source of transmission of the video coded signal is changed.

Seventh Embodiment

The construction of the multimedia communication system according to the seventh embodiment is the same as that of the system according to the fifth embodiment shown in FIG. 8. The internal construction of the communication service unit 2 according to the seventh embodiment is the same as the construction according to the fifth embodiment shown in FIG. 9. Signals transmitted in directions opposite to the illustrated directions may be present between the transmission terminal media multiplexing/demultiplexing units 22a-22n and the units 23, 24, 25. Also, signals transmitted in directions opposite to the illustrated directions may be present between the units 23, 24, 25 and the reception terminal media multiplexing/demultiplexing unit 26. These signals transmitted in the opposite directions do not have direct relevance to the present invention so that the illustration and description thereof are omitted.

A description will now be given of the operation according to the seventh embodiment.

In a similar configuration as the multimedia communication system according to the sixth embodiment, the system operates such that negotiation for capability is performed between the communication service unit 2 and the transmission terminals 1a-1n and between the communication service unit 2 and the reception terminal 3 when the communication is started, so that the transmission terminals and the receiving terminals all use the same video coding method (for example, ITU-T H.263) that uniquely determines the video coding parameter. A majority of the functional units constituting the communication service unit 2 according to the seventh embodiment perform the same operations as the units constituting the communication service unit 2 according to the sixth embodiment so that the description thereof is omitted. The operation characteristic to the communication service unit 2 according to the seventh embodiment, i.e. the operation of the communication control unit 28, will be described.

When the communication is started, the communication control unit 28 of the communication service unit 2 according to the seventh embodiment communicates with the transmission terminals 1a-1n and with the reception terminal 3, using communication channels carrying calls independent of the calls on the communication channels for multimedia communication, in accordance with an instruction from the unit controller (not shown). In this process, the video coding method (for example, ITU-T H.263) that uniquely determines the video coding parameter that the transmission terminals 1a-1n may use for coding and the reception terminal 3 may use for decoding, is selected so that the entirety terminals are directed to use the selected video coding method.

As a result, in a similar configuration as the sixth embodiment, the transmission terminals 1a-1n and the reception terminal 3 commonly use the same video coding method uniquely determining the video coding parameter and requested by the communication service unit 2. As a result, the parameter uniquely determined by the video coding method is used in a stream input to the communication service unit 2 from the entirety of the transmission terminals 1a-1n.

In the description above of the seventh embodiment, the operation of the transmission terminals 1a-1n is described as being separate from the operation of the reception terminal 3 for simplicity of the description. In a similar configuration as multimedia communication system according to the second embodiment shown in FIG. 3, the communication terminals 1a-1n may be configured as communication terminals capable of both transmission and reception to provide the same functions and effects. In this case, as described in the fifth embodiment, the communication terminals 1a-1n use the communication control channel carrying calls independent of the calls in the physical channel for transfer of multimedia information (indicated by solid lines in FIG. 3), so as to exchange messages with the communication service unit 2 for negotiation for capability.

As described, according to the seventh embodiment, the communication channels carrying calls independent of the calls on the communication channels for multimedia communication are provided between the communication service unit 2 and the transmission terminals 1a-1n and between the communication service unit 2 and the reception terminal 3. The video coding method (for example, method complying with ITU-T H.263) that uniquely determines the video coding parameter that the reception terminal 3 may use for decoding and the transmission terminals 1a-1n may use for coding is supplied by the communication service unit 2 to the respective terminals. The parameter may be supplied to the terminals by performing capability negotiation when the communication is started, using the independent communication control channels. Alternatively, the method may be supplied through the user's manual setting. Accordingly, it is ensured that the entirety of the terminals use the same video coding parameter. The reception terminal 3 is capable of decoding the video coded signal efficiently when the transmission of the video coded signal is started or when the source of transmission of the video coded signal is changed.

### INDUSTRIAL APPLICABILITY

As described, the communication service unit and the multimedia communication method according to the present invention is adapted for multimedia information transmission and reception between a plurality of communication terminals and enables each communication terminal to change its source reception of information while performing transmission of information. Accordingly, the invention is suitably to implement multimedia communication capable of efficient information provision and acquisition of desired information.

1. A communication service unit demultiplexing information transmitted from a plurality of transmission terminals into media information of a single or a plurality of media types, selecting for each media type a transmission terminal used for transmission to a reception terminal, multiplexing the media information of the plurality of media types, and transmitting the multiplexed information to the reception terminal, wherein
when a transmission source terminal is changed for one or a plurality of media types, a media coding parameter stored in memory and used in a new transmission source terminal is supplied to the reception terminal.

2. The communication service unit according to claim 1, wherein a logical channel for transfer of media information to the reception terminal is reestablished when a transmission source terminal transmitting the media information is changed, and a control logical channel is used to transmit the media coding parameter stored in memory and used in the new transmission source terminal to the reception terminal.

3. The communication service unit according to claim 2, wherein the logical channel for transfer of the media information to the reception terminal is established using a unidirectional logical channel.

4. The communication service unit according to claim 1, wherein, when a transmission source terminal transmitting the media information is changed, the media coding parameter stored in memory and used in the new transmission source terminal is multiplexed in the media information so that the multiplexed information is transmitted to the reception terminal using a logical channel for transfer of the media information.

5. The communication service unit according to claim 1, wherein the transmission terminal is capable of both transmission and reception of media information.

6. The communication service unit according to claim 1, wherein audio information is included as the media information.

7. The communication service unit according to claim 1, wherein video information is included as the media information.

8. The communication service unit according to claim 1, wherein user data information is included as the media information.

9. A communication service unit demultiplexing information transmitted from a plurality of transmission terminals into media information of a single or a plurality of media types, selecting for each media type a transmission terminal used for transmission to a reception terminal, multiplexing the media information of a plurality of media types, and transmitting the multiplexed information to the reception terminal, wherein,
when communication is started, the transmission terminals are controlled so that, for a given media type or given media types, the entirety of the transmission terminals in a given group use for media coding a common media coding parameter that the entirety of the reception terminals in the group use for decoding.

10. The communication service unit according to claim 9, wherein, when the communication is started, the media coding parameter used in the transmission terminals is controlled by allowing the entirety of the transmission terminals and the reception terminals in a given group to negotiate for capabilities.

11. The communication service unit according to claim 9, wherein, when the communication is started, the media coding parameter used in the transmission terminals is controlled by allowing the entirety of the transmission terminals and the reception terminals in a given group to negotiate for capabilities using control logical channels.

12. The communication service unit according to claim 9, wherein, when the communication is started, the media coding parameter used in the transmission terminals is controlled by allowing the entirety of the transmission terminals and the reception terminals in a given group to negotiate for capabilities using communication channels carrying calls independent of calls on communication channels for multimedia communication.

13. The communication service unit according to claim 9, wherein the transmission terminal is also a reception terminal and is capable of both transmission and reception of the media information.

14. The communication service unit according to claim 9, wherein voice information is included as the media information.

15. The communication service unit according to claim 9, wherein video information is included as the media information.

16. The communication service unit according to claim 9, wherein user data information is included as the media information.

17. A communication service unit demultiplexing information transmitted from a plurality of transmission terminals into media information of a single or a plurality of media types, selecting for each media type a transmission terminal used for transmission to a reception terminal, multiplexing the media information of the plurality of media types, and transmitting the multiplexed information to the reception terminal, wherein,
when communication is started, the transmission terminals are controlled to use, for media coding of a given media type or given media types, a media coding method that uniquely determines a media coding parameter for the entirety of the transmission terminals and the reception terminals in a given group.

18. The communication service unit according to claim 17, wherein, when the communication is started, the media coding method used in the transmission terminal is controlled by allowing the entirety of the transmission terminals and the reception terminals in a given group to negotiate for capabilities.

19. The communication service unit according to claim 17, wherein, when the communication is started, the media coding method used in the transmission terminal is controlled by allowing the entirety of the transmission terminals and the reception terminals in a given group to negotiate for capabilities using control logical channels.

20. The communication service unit according to claim 17, wherein, when the communication is started, the media coding parameter used in the transmission terminal is controlled by allowing the entirety of the transmission terminals and the reception terminals in a given group to negotiate for capabilities using communication channels carrying calls independent of calls on communication channels for multimedia communication.

21. The communication service unit according to claim 17, wherein the transmission terminal is also a reception terminal and is capable of both transmission and reception of the media information.

22. The communication service unit according to claim 17, wherein audio information is included as the media information.

23. The communication service unit according to claim 17, wherein video information is included as the media information.

24. The communication service unit according to claim 17, wherein user data information is included as the media information.

25. A multimedia communication method demultiplexing information transmitted from a plurality of transmission terminals into media information of a single or a plurality of media types, selecting for each media type a transmission terminal used for transmission to a reception terminal, multiplexing the media information of the plurality of media types, and transmitting the multiplexed information to the reception terminal, wherein
when a transmission source terminal is changed for one or a plurality of media types, a media coding parameter stored in memory and used in a new transmission source terminal is supplied to the reception terminal.
